(19) United States
(12) Patent Application Publication
(10) Pub. No.: US 2026/0133313 A1
(43) Pub. Date: May 14, 2026

(54) SYSTEM AND METHOD FOR PHASE CLOSURE MASKING FOR INTERFEROMETRIC SYNTHETIC APERTURE RADAR IMAGES

(71) Applicant: CGG SERVICES SAS, Massy Cedex (FR)

(72) Inventors: Fei LIU, Crawley (GB); Rachel HOLLEY, Tunbridge Wells (GB)

(21) Appl. No.: 18/946,094

(22) Filed: Nov. 13, 2024

(51) Int. Cl. G01S 13/90; G01S 7/295; G01S 13/88

(52) U.S. Cl. CPC G01S 13/9023; G01S 7/295; G01S 13/885

(57) ABSTRACT

A device and method for determining surface displacement in a structure based on interferometric synthetic aperture radar (InSAR) includes receiving a stack of wrapped interferograms, performing multilooking on the stack of wrapped interferograms to generate multilooked interferograms, calculating phase closure residual maps based on the multilooked interferograms, calculating average phase closure residual maps based on the phase closure residuals, masking pixels in the multilooked interferograms, based on the average phase closure residual maps, to obtain masked interferograms, unwrapping the masked interferograms to obtain unwrapped, masked interferograms, and generating an InSAR time series product based on the unwrapped, masked interferograms.

### BACKGROUND OF THE INVENTION

### Technical Field

Embodiments of the subject matter disclosed herein generally relate to a system and method for monitoring ground displacement over time, and more particularly, to an interferometric Synthetic Aperture Radar (SAR) imaging technique that evaluates the noise level at pixel resolution in space.

### Discussion of the Background

SAR is a type of radar technology used to create high-resolution images of objects, landscapes, and terrain. Unlike traditional radar, which uses an instantaneous acquisition from a single antenna, SAR combines data acquired over a short period of time, as the radar moves along a flight path (such as on an airplane or satellite) over a surface. This movement simulates a much larger antenna, or “synthetic aperture,” allowing SAR to achieve a much finer resolution than would be possible with a physical antenna of the same size.

A typical SAR method emits microwave pulses towards the ground or the target area/surface. These pulses reflect off objects on the ground and return to the radar antenna. As the radar platform moves, the radar collects multiple return signals from an object, from slightly different angles. The collected data is then processed using advanced algorithms to form a detailed, high-resolution image of the object.

Interferometric Synthetic Aperture Radar (InSAR) is a technique that measures phase differences between two or more SAR images, which provide information on the surface displacements (for the surfaces imaged by the SAR images) between the acquisition times. InSAR builds on SAR technology for measuring ground deformation, topography, and surface displacement over time, with high precision, by analyzing the phase differences between two or more SAR images of the same area/object taken from slightly different positions and/or at different times. The phase information from these SAR images is compared to create an interferogram, which shows the phase differences between the images. These phase differences can result from changes in the distance between the radar and the ground, often due to ground/object movement or deformation.

By analyzing the phase differences, InSAR can detect minute displacements of the Earth's surface, often on the order of centimeters or even millimeters. This is particularly useful for monitoring tectonic and volcanic activity, subsidence, landslides, or infrastructure stability (e.g., a dam). InSAR allows for the observation of displacements over time, providing valuable data for long-term monitoring.

However, the phase measurements in interferograms are not always reliable, due to decorrelation noise caused by the change of satellite's position, and physical properties of the objects on the ground, like surface disturbance or soil moisture variations. The noisy pixels in the interferograms have to be identified and masked to avoid unreliable measurements and prevent the propagation of errors into surrounding areas during further processing (e.g., the steps of filtering and phase unwrapping). This results in loss of coverage which remains one of the key issues in the current InSAR time series product.

Thus, there is a need for a new system and method that are capable of determining the decorrelation, so that a more reliable pixel quality estimation is achieved.

### SUMMARY OF THE INVENTION

According to an embodiment, there is a method for determining surface displacement in a structure based on interferometric synthetic aperture radar (InSAR). The method includes receiving a stack of wrapped interferograms, performing multilooking on the stack of wrapped interferograms to generate multilooked interferograms, calculating phase closure residual maps based on the multilooked interferograms, calculating average phase closure residual maps based on the phase closure residuals, masking pixels in the multilooked interferograms, based on the average phase closure residual maps, to obtain masked interferograms, unwrapping the masked interferograms to obtain unwrapped, masked interferograms, and generating an InSAR time series product based on the unwrapped, masked interferograms.

According to another embodiment, there is a computing system for determining displacement in a structure based on interferometric synthetic aperture radar (InSAR). The computing system includes an interface configured to receive a stack of wrapped interferograms, and a processor connected to the interface. The processor is configured to: perform multilooking on the stack of wrapped interferograms to generate multilooked interferograms, calculate phase closure residual maps based on the multilooked interferograms, calculate average phase closure residual maps based on the phase closure residuals, mask pixels in the multilooked interferograms, based on the average phase closure residual maps, to obtain masked interferograms, unwrap the masked interferograms to obtain unwrapped, masked interferograms, and generate an InSAR time series product based on the unwrapped, masked interferograms.

### BRIEF DESCRIPTION OF THE DRAWINGS

For a more complete understanding of the present invention, reference is now made to the following descriptions taken in conjunction with the accompanying drawings, in which:

FIG. 1A is a flow chart of a method for determining the decorrelation noise from the phase closure in the InSAR processing chain, FIG. 1B is a flow chart of a method for calculating a pixel mask, and FIG. 1C. is a flow diagram of a method for calculating the pixel mask based on a residual value and a coherence value;

FIG. 2 schematically illustrates an example of a multilooking operation that may cause non-zero phase closure residual;

FIGS. 3A to 3C illustrate phase closure residuals for a triplet of SAR images, with FIG. 3A showing a histogram of the sum of wrapped interferograms in a phase closure, with values centroided on modulo 2π, FIG. 3B showing the values in FIG. 3A being re-wrapped by subtracting or adding multiples of 2π, and FIG. 3C showing the absolute values of FIG. 3B, used in a phase closure residual map;

FIG. 4A shows an example of an average residual map and FIG. 4B shows a corresponding mask file generated based on the average residual map;

FIG. 5 illustrates an example of phase unwrapping for retrieving unwrapped data from wrapped data;

FIGS. 6A and 6B show an example of an InSAR time series product, with FIG. 6A showing the velocity map which focuses on a dam, and FIG. 6B showing a time series plot of an example pixel in a risk area of the dam;

FIGS. 7A and 7B compare the coverage in InSAR velocity map when applying conventional coherence-based masking to a stack of interferograms (image in FIG. 7A), versus phase closure masking (image in FIG. 7B);

FIG. 8 is a schematic illustration of the complex values of various pixels in a given window in an interferogram;

FIG. 9 schematically illustrates a closure-guided multilooking process for generating a multilooked interferogram;

FIGS. 10A to 10D illustrate phase closure residual changes over time for various structures;

FIG. 11 is a flowchart of a method for determining an object displacement by using phase closure residuals for evaluating the noise level at pixel resolution in space;

FIG. 12 is an example of an interferogram network that contains multiple phase closures; and

FIG. 13 is a schematic diagram of a computing system that implements one or more of the methods discussed in this disclosure.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a weak region in a dam. However, the embodiments to be discussed next are not limited to detecting displacements in a dam, but may be applied to objects or earth surface that may be imaged by satellites.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, the application of phase closure masking in InSAR time series analysis is used for characterizing the decorrelation noise for each pixel in an interferogram image. A method that uses the phase closure for the identification of high-quality pixels to improve the InSAR products is discussed herein. Note that the existing and published studies of phase closure focus on the potential for soil moisture measurements and fading signal corrections of short temporal InSAR time series analysis, and not for characterizing the decorrelation noise of pixels.

More specifically, this embodiment uses the phase closure, which is a property of a closed loop formed by three interferograms (e.g., AB, BC, and CA) between three SAR images (A, B, and C). Intuitively, if the measurements are consistent with each other, the sum of phases around the loop (the closure) should be zero, as they ought to cancel each other. However, the phase closure is non-zero due to the decorrelation noise, and its residual (the non-zero part) is related to the characteristics of the decorrelation noise.

Prior to discussing this method in more detail, it is noted that the phase closure method refers to a property of the loop formed by three interferograms (AB, BC, and CA noted above) between three SAR images (A, B, and C) and a “phase closure residual” refers to a non-zero part (modulo 2π) of the sum of phase values in the phase closure. Various datasets are used for describing this method. These datasets include input datasets, phase closure residual maps, average residual map, a stack of masked wrapped interferograms, a stack of masked unwrapped interferograms, and InSAR time series product. Each of these sets are briefly defined here, and discussed in more detail later, when the steps of the method are introduced.

The input datasets include a stack of wrapped interferograms, coherence maps, and a corresponding network file. The phase closure residual maps include an intermediary dataset produced by the method. The number of residual maps is the same as the number of phase closures in the network. The average residual map is also an intermediary dataset, produced by the method, and this dataset is the average map of multiple phase closure residual maps. The stack of masked wrapped interferograms is another intermediary dataset produced by the method, with a designated value (threshold) indicating masked out pixels. The stack of masked unwrapped interferograms is an intermediary dataset produced by the method, after phase unwrapping the stack of masked wrapped interferograms. The InSAR time series product is the end output dataset of the method, and this dataset includes, but is not limited to, a velocity map and time series data of each pixel on the map.

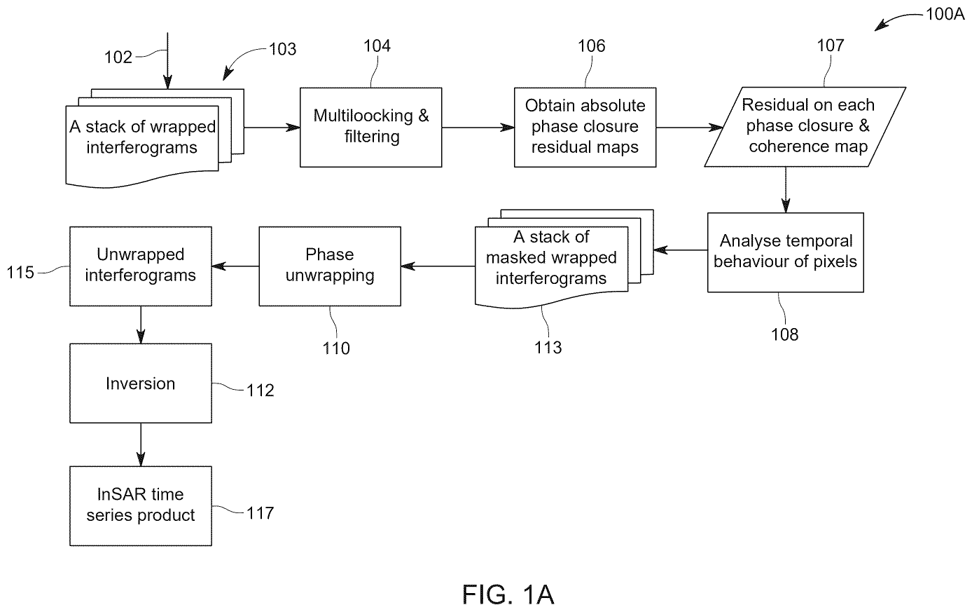

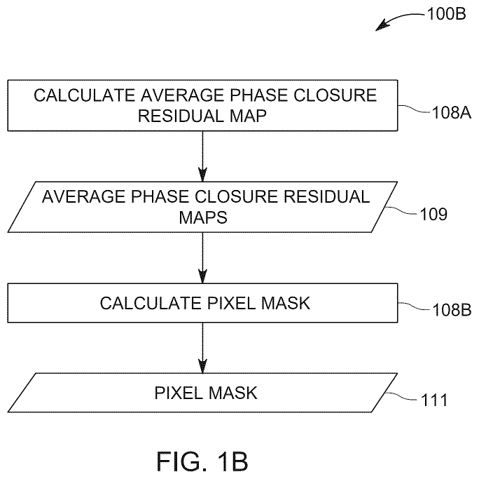

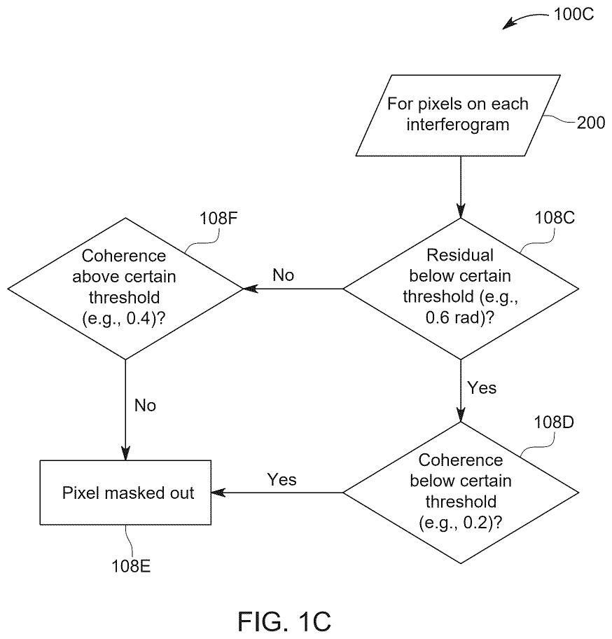

The method 100A for generating InSAR time series, which is schematically illustrated in FIGS. 1A to 1C, uses even numbers for steps and odd numbers for objects or data. The method 100A receives in step 102 a stack 103 of full-resolution, unfiltered, wrapped interferograms. This stack is normally generated by the operator of the method. Then, the method performs a step 104 of multilooking and filtering the received set 103 of interferograms.

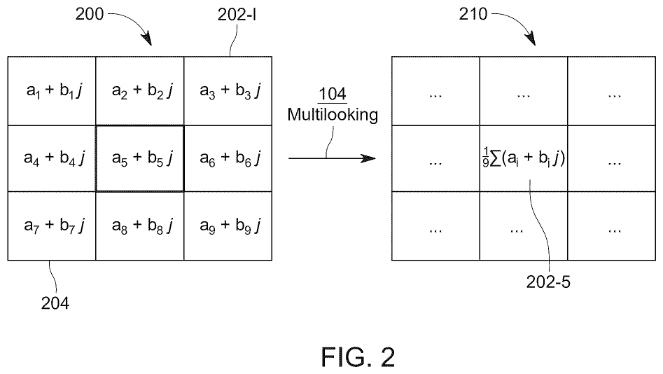

Multilooking is the spatial filtering of the input interferograms by averaging the complex values of groups of pixels to improve the signal to noise ratio. The output of the multilooking step 104 is a set of interferograms in which values of the pixels have been changed (e.g., averaged) and some pixels have been eliminated. This set of interferograms is called multilooked interferograms. This step is schematically illustrated in FIG. 2. FIG. 2 shows an interferogram 200 having plural pixels 202-I, where I is a positive integer. I may have a value in the order of thousands to millions in an actual interferogram. The complex values aᵢ+jbᵢ of the pixels in a selected group (here a 3×3 window 204 is shown, but the group size and spatial distribution may vary) are averaged during the multilooking step to improve the signal to noise ratio. Note that FIG. 2 shows the averaged interferogram 210 having each pixel (only the value of pixel 202-5 is explicitly shown) averaged over all the pixel values in the corresponding window 204. Multilooking and spatial filters are non-linear operations performed on the phase values of individual interferograms, which causes non-zero phase closure residuals. This is the case because the phase values (note that a complex number aᵢ+jbᵢ has a phase defined by the coefficients aᵢ and bᵢ, where j is the imaginary number) of interferograms are obtained from the angle of the complex number. The multilooking is a non-linear operator to the phase because of the property

$$angle \{ \frac{1}{N} {\sum }_{i = 1}^{N} ( {a}_{i} + {b}_{i} j ) \} \neq \frac{1}{N} {\sum }_{i = 1}^{N} angle ( {a}_{i} + {b}_{i} j ) .$$

Returning to FIG. 1A, step 104 breaks the phase closure consistency in the interferograms of the set 103 and causes non-zero phase closure residuals. However, the use of adaptive algorithms (e.g., a closure-guided multilooking approach discussed later), which filter or average pixels based on their similarity instead of a fixed size window, can minimize phase closure residual and obtain overall higher quality interferograms.

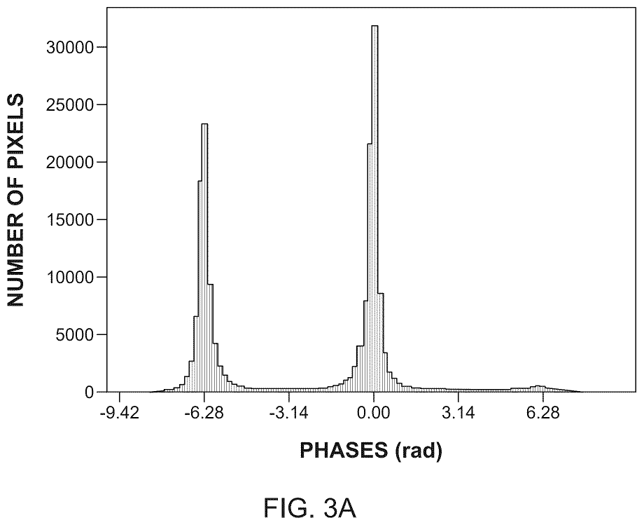

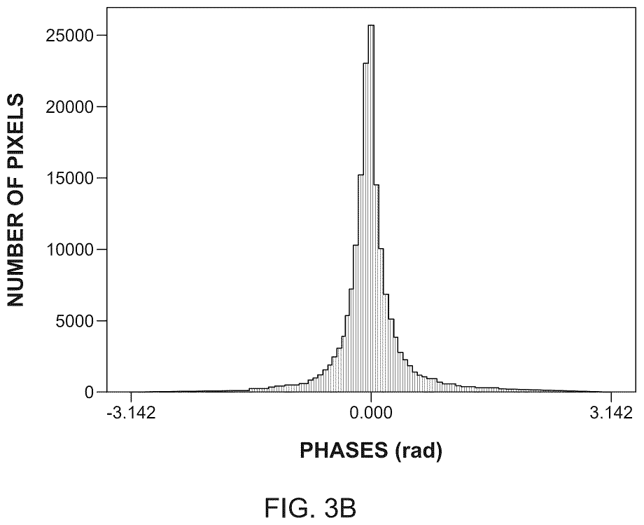

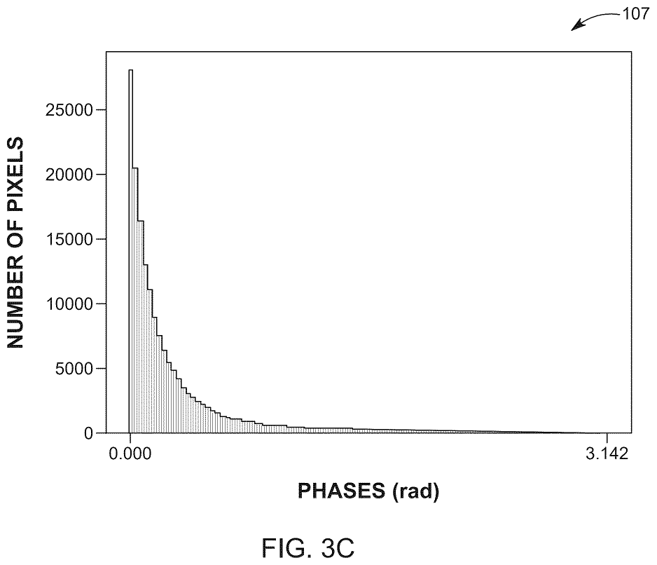

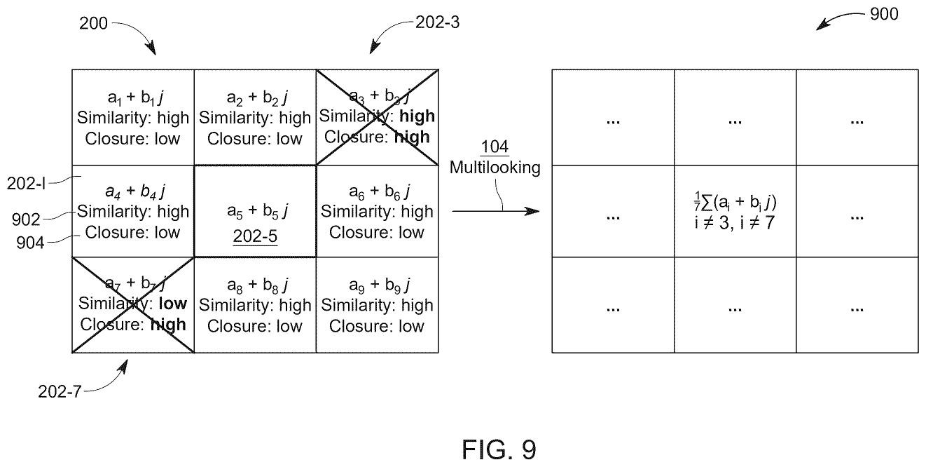

Step 106 extracts all (or a selected subset of) the possible combinations of three interferograms that form phase closures (triplets) from the input network file 103. Then, the method sums up the phase values of the wrapped interferograms in each phase closure, which can be displayed on a histogram centroided modulo 2π, as illustrated in FIGS. 3A to 3C. These figures illustrate an example of phase closure residuals for a triplet (4, 5, 6), where numbers 4, 5, and 6, represent the indices of SAR images in a network file (to be discussed later about FIG. 9). FIG. 3A is a histogram of the sum of wrapped interferograms in the phase closure, with values centroided on modulo 2π. FIG. 3B shows the values of FIG. 3A, re-wrapped by subtracting or adding multiples of 2π so that this figure shows the phase closure residuals. FIG. 3C shows the absolute values of FIG. 3B, which are used in the phase closure residual map. In other words, this step calculates the re-wrapped value of each sum (FIG. 3A) by subtracting or adding multiples of 2π until the residual lies in the range −π to π (FIG. 3B). Then, this step obtains the absolute values to generate the phase closure residual maps 107, whose values range from 0 to π. Coherence maps may also be associated with the phase closure residual maps as discussed with regard to the next step.

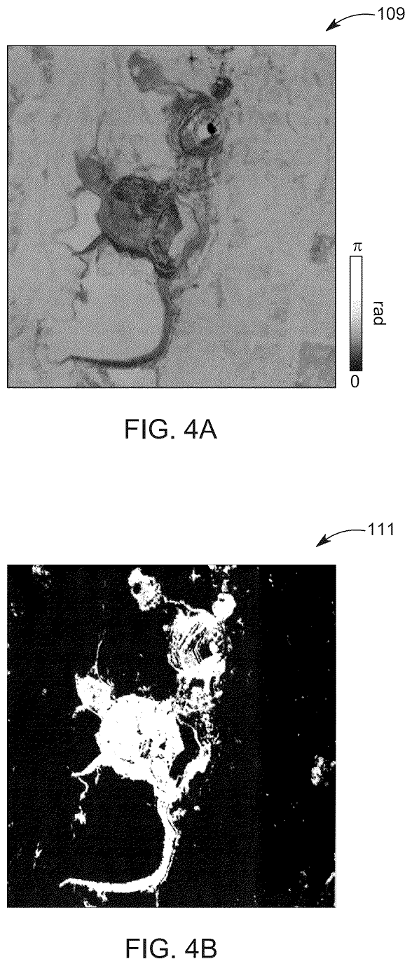

In step 108, the method analyses the temporal evolution of the phase closure residuals 107 to determine the quality of each pixel over time. The exact closure value varies slightly across different SAR image combinations, but averaging over a period of time provides a good estimate of the pixel quality. Therefore, one approach is to use a moving average time window over the phase closure residual maps 107 (which are absolute maps, i.e., they include the absolute values of the phase closure residual in the closure) to calculate in substep 108A, (see FIG. 1B) the average phase closure residual maps 109, which can indicate the overall quality of the pixels through a certain observation period. FIG. 4A shows an example of the average phase closure residual map 109 and FIG. 4B shows a corresponding mask file 111 generated in step 108B (see FIG. 1B) based on the map 109, using Sentinel-1 data across a gold mine in Australia. In this example, the average residual map 109 is calculated by stacking InSAR data over a period of time (for example, a few months or years). Each pixel of the average residual map 109 has an average value (e.g., phase closure values) associated with it. The mask file 111 is obtained by applying a threshold value to the map 109 in FIG. 4A. In other words, the phase closure values above the threshold value are masked out (black in FIG. 4B) while the phase closure values below the threshold (white in FIG. 4B) are kept. Any value within the 0 to π range of the average residual may be used for the threshold value.

This procedure can also be combined with the coherence values to further filter the pixel selection results, such as keeping the pixels whose coherence is above a certain threshold (e.g., 0.4) and masking out those below a certain threshold (e.g., 0.2). A coherence procedure generates the coherence values, which are normalized values between 0-1 to indicate the quality of a pixel (the higher the better). The coherence γ is represented by a correlation coefficient within a fixed spatial window (typically at least 3×3) centred on that pixel, and may be given by the following equation:

$$γ = \frac{\vert {\sum }_{i} {x}_{i} {y}_{i}^{*} \vert}{\sqrt{{\sum }_{i} {x}_{i} {x}_{i}^{*} {\sum }_{i} {y}_{i} {y}_{i}^{*}}} ,$$

where xᵢ and yᵢ are the values (complex numbers) of the pixels that form the interferogram (e.g., xᵢ are from SAR image A and yᵢ are from SAR image B, where the interferogram is made based on images A and B) and “*” is the complex conjugate operation.

FIG. 1C shows a possible method 100C for generating the mask file 111 based (1) on the residual in the average phase closure residual map 109 being above or below a first threshold, and (2) the coherence being within a certain range. More specifically, FIG. 1C shows that for each pixel on each interferogram 200, the corresponding residual from the average phase closure residual map 109 is compared in step 108C to the first threshold, e.g., 0.6 rad, but other values may be used. If the residual is below the first threshold, the YES branch in the figure, the method then compares 108D the coherence value to a second threshold, e.g., 0.2, but other values may be used. If the coherence is lower than the second threshold, the method masks out 108E the pixel, and thus generates the masked wrapped interferograms 113. If the result of step 108C is that the residual is above the first threshold, the NO branch, the method advances to step 108F, where the coherence is compared to a third threshold, e.g, 0.4, but other values may be used. Note that the third threshold is different from the second threshold. If the coherence is below the third threshold, the method advances to step 108E discussed above, and the pixel is excluded. Overall, this method tries to retain some high quality pixels whose coherence values fall within a relatively low value range (e.g., 0.2-0.4 in this example) due to surrounding low quality pixels, by checking their phase closure residuals (e.g., 0.6 rad in this example).

Based on the above discussed pixel quality evaluation, step 108 creates the mask files 111 (an example of such a mask is illustrated in FIG. 4B), for each interferogram 200, to mask out the low-quality pixels, and generates a stack of masked interferograms 113, as schematically illustrated in FIGS. 1A and 1B.

Returning to FIG. 1A, in step 110, the method performs a step 110 of phase unwrapping of the masked, wrapped interferograms 113, generated in step 108, to generate unwrapped interferograms 115. More accurate and robust unwrapping results can be achieved given better pixel selection results. Also in this step, by checking the phase closure residuals of the unwrapped interferograms, unwrapping errors can also be identified, and potentially corrected using methods such as weighted or iterative unwrapping, to further improve overall accuracy.

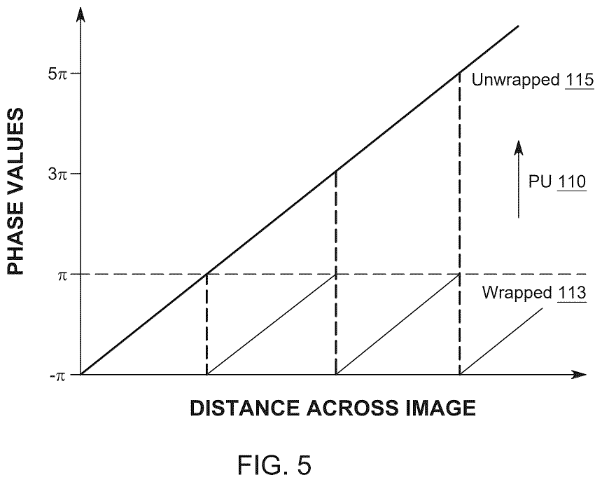

It is noted that when an interferogram is initially generated, the phase values cycle within a limited range, typically between −π and π radians, due to the circular nature of phase measurements. This is called a wrapped interferogram. Step 110 unwraps the wrapped interferograms 113. This process of phase unwrapping retrieves an estimate of the true continuous phase difference values from the observed wrapped interferogram, by adding or subtracting multiples of 2π to the phase values in the wrapped interferograms 113, as schematically illustrated in FIG. 5. Thus, an unwrapped interferogram 115 is the interferogram after phase unwrapping, where the phase values are no longer confined within a limited range.

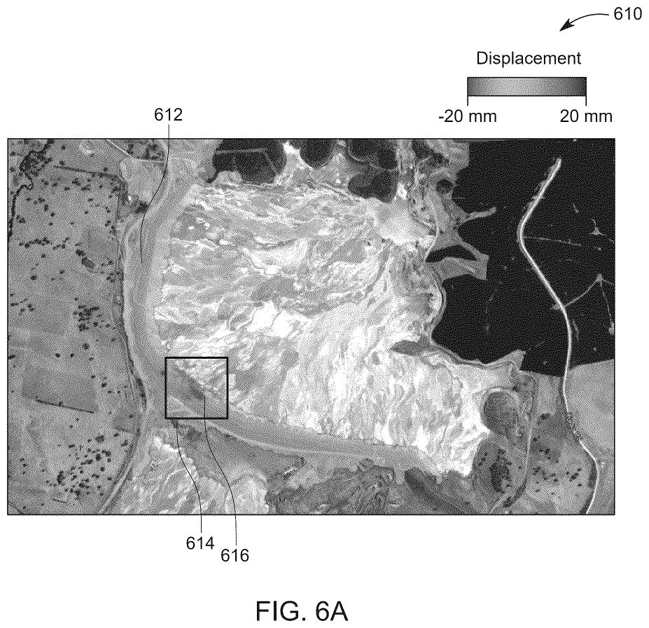

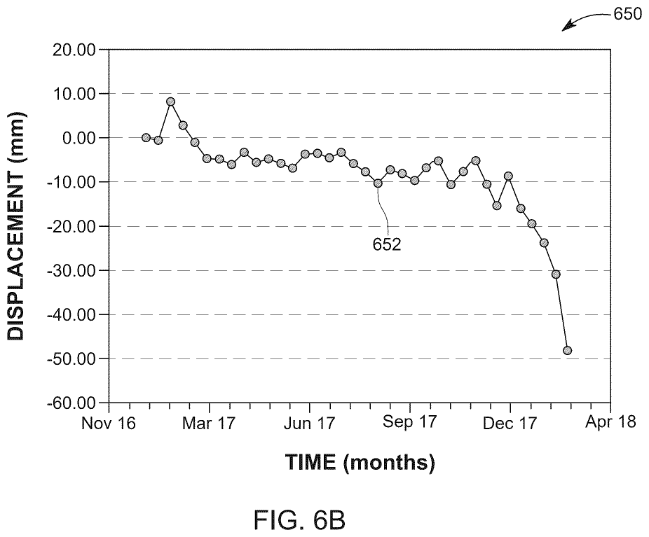

Returning to FIG. 1A, step 112, which is the final step, is InSAR time series analysis on the unwrapped interferograms 115, which performs an inversion which solves for a displacement for each time epoch spanned by the SAR image stack and an associated mean velocity. The result of this step is the InSAR time series product 117, which includes, but is not limited to, a velocity map 610 as illustrated in FIG. 6A and a time series 650 for each pixel on the map, as illustrated in FIG. 6B. In one embodiment, the InSAR time series product 117 includes an earth deformation map over a given period of time (e.g., months or years). FIG. 6A illustrates the velocity map 610, which focuses on a dam 612, where a rectangle 614 highlights a risk area 616 (darker color) of the dam. Note that a darker color in this figure illustrates a more noticeable displacement of the imaged surface. FIG. 6B shows the time series plot 650 of an example pixel in the risk area 616, with the dots 652 representing the measurements for the pixel in each SAR image. Note that the X axis in FIG. 6B show the times at which the SAR images were collected while the Y axis indicates the displacement of the example pixel.

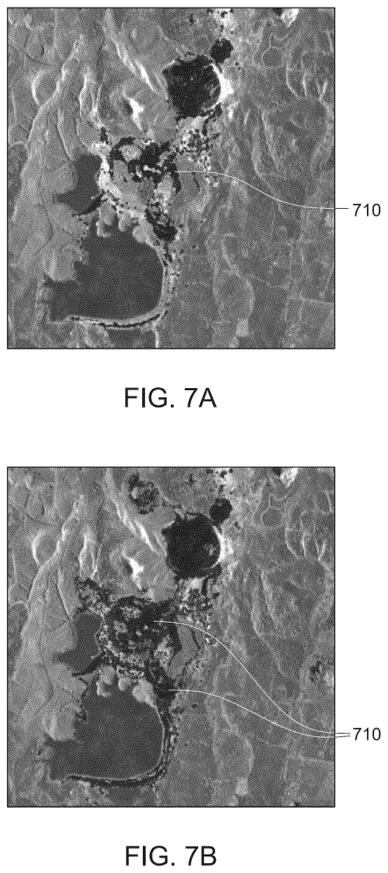

When the results 117 of the method 100A are compared to the conventional coherence masking strategy, phase closure masking can achieve better coverage and an overall higher quality velocity map, as illustrated in FIGS. 7A and 7B. These figures compare the coverage in InSAR velocity map (with SAR intensity image as background and dark pixels 710 indicate the coverage of final InSAR time series product) when applying conventional coherence-based masking to a stack of interferograms (FIG. 7A), versus phase closure masking (FIG. 7B). The coherence-based masking gives 4.2% total coverage, while the phase closure masking gives 11.1% total coverage.

Thus, one advantage of the phase closure masking method 100A of FIGS. 1A to 1C is that it provides a way to evaluate the noise level at pixel resolution in space, compared to the conventional coherence-based masking strategy. Since coherence values are calculated based on a fixed window in space, the coherence value of a high-quality pixel will be underestimated if it is surrounded by low-quality pixels, and vice versa. Phase closure residual in method 100A is calculated pixel by pixel, after multilooking, and when combined with the coherence, as illustrated in FIG. 1C, which picks out the temporal variance, a more reliable pixel quality estimation is achieved.

Another potential advantage of the method 100A is that, through the entire workflow, the phase closure masking method 100A does not involve any assumptions of the input dataset (like the deformation type, linear or non-linear) or any complex computations, and therefore it is pretty robust for different datasets (X, C, and L band SAR data) and efficient even for large volumes of interferograms. Furthermore, this method could also be extendedly used for closure-guided multilooking and change detection. Note that a “change detection” is different from a “surface displacement” as the change detection normally refers to a difference in the physical properties of the surface in a given image while the surface displacement measured by InSAR may refer to a change in the position of that surface. More details for this approach are discussed below.

While the multilooking procedure results in some inter-dependence between the estimated quality for each pixel and its neighbours, the phase closure information can itself be used to minimize this effect. As described above, the phase values of the pixels are changed by multilooking in one embodiment, where the sum of these changes is the source of the non-zero phase closure residuals. Closure-guided multilooking evaluates the phase changes involved in the multilooking operation, considering a target pixel averaged in turn with each candidate pixel in a selected set of neighbours, rather than all pixels in a fixed size window (see FIG. 2) as traditionally performed. The closure-guided multilooking can then be used to identify one or more pixels with the greatest similarity to the target pixel (and therefore lowest closure residual), which can be multilooked together.

If the phase value of a pixel in an interferogram had only minor changes after the multilooking, the phase closure residual it would contribute will also be small, which is likely to indicate a better-quality pixel. This can be used as a method to select one or more similar pixels for multilooking, before proceeding to calculate phase closures.

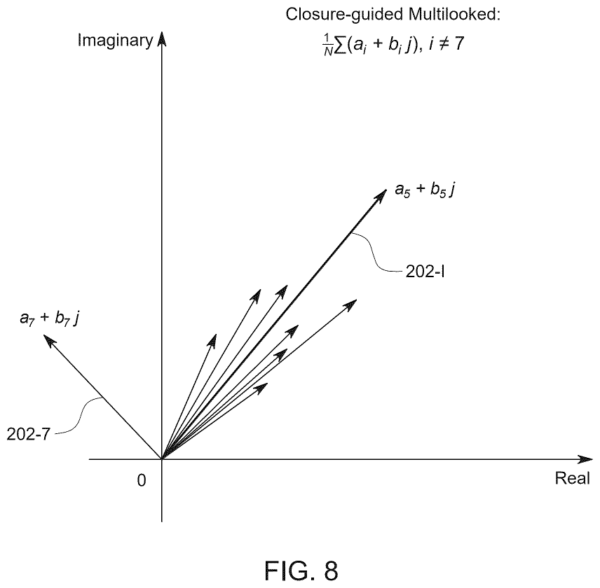

This approach is schematically illustrated in FIG. 8, which shows example values of the pixels 202-I in FIG. 2 in a complex plane. Note that the sum of complex numbers is equivalent to the sum of vectors in a complex plane, and that closer vector directions (phase values) will provide smaller direction variations (i.e., the difference between

$$angle \{ \frac{1}{N} {\sum }_{i = 1}^{N} ( {a}_{i} + {b}_{i} j ) \} and \frac{1}{N} {\sum }_{i = 1}^{N} angle ( {a}_{i} + {b}_{i} j ) ) .$$

In this example the direction of the 7^{th} pixel 202-7 is very different from all the other pixels, and thus, a larger variation of the phase value will be introduced, as well as a larger phase closure residual, if that pixel is included, as in the conventional multilooking shown in FIG. 2.

In some cases, low quality candidate pixels may have a similar interferogram value to that of the target pixel by random chance, and since these are likely to show high variability over time, the resulting average phase closure residual, when multilooking them together, would be expected to be high. In addition to the single-interferogram evaluation, it is also possible to calculate the average phase closure residual for each candidate across multiple interferograms, to provide a more robust estimate of the candidate pixel similarities. This step is more computationally intensive, so in some cases it may be appropriate to use the single- and multi-interferogram calculations iteratively, on a subset of candidate pixels.

FIG. 9 shows a target pixel 202-5 and candidate pixels (all other pixels 202-I in the figure), similar to FIG. 2, but with additional information on the similarity 902 of each candidate pixel's complex value to that of the target 202-5, and also on the resulting average closure residual 904, when that candidate pixel is multilooked with the target 202-5 across multiple interferograms. As shown in FIG. 8, pixel 202-7 does not have a similar value 902 with the other pixels and thus, according to this embodiment, this pixel is excluded from the multilooking calculations. Note that pixel 202-7 has a low similarity to a complex value of the target pixel 202-5. Pixel 202-3 does have a similar value 902, in this interferogram, to the complex value of the target pixel 202-5, however the average closure residual 904 across multiple interferograms is high, indicating that this pixel is nonetheless of poor quality and should also be excluded from the multilooking calculations. Thus, in this embodiment, only the candidate pixels having a high similarity 902 and a low average closure residual 904 are selected to be included in the multilooking calculations. The results of the multilooking step in FIG. 9 is the mulitlooked interferogram 900.

Another potential application of the phase closure residual is for change detection, as mentioned above. InSAR is generally used for monitoring the surface displacements. For InSAR to measure surface displacements, the physical properties of the surface should remain the same through time, so that high quality measurements can be obtained. Any changes to the physical properties of the surface (e.g., soil moisture content), or the surface itself (e.g., vegetation growth) will cause decorrelation noise. In the worst case, the signal becomes totally decorrelated and the phase measurements are overwhelmed by noise. This decorrelation noise level caused by surface changes can be reflected in the value of the phase closure residual, making it possible to detect these changes. Compared to conventional intensity-based approaches, this method utilizes phase information and may obtain different and complementary information.

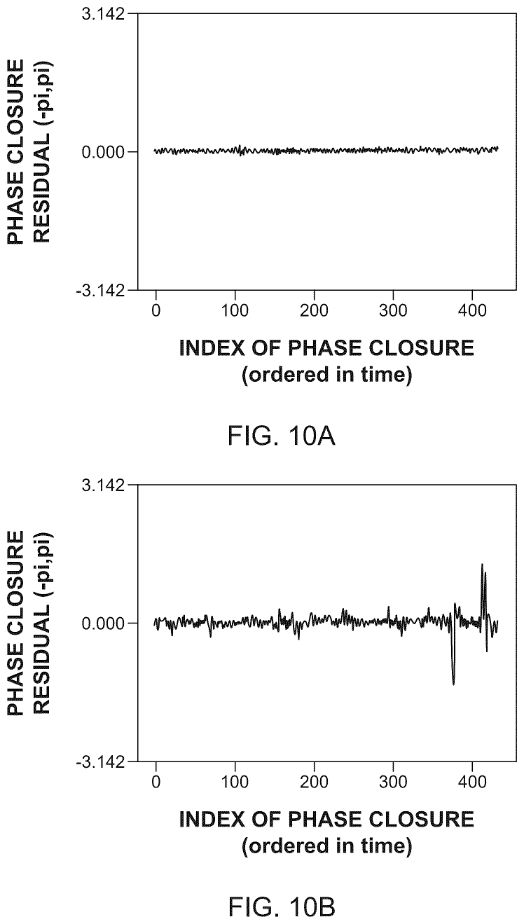

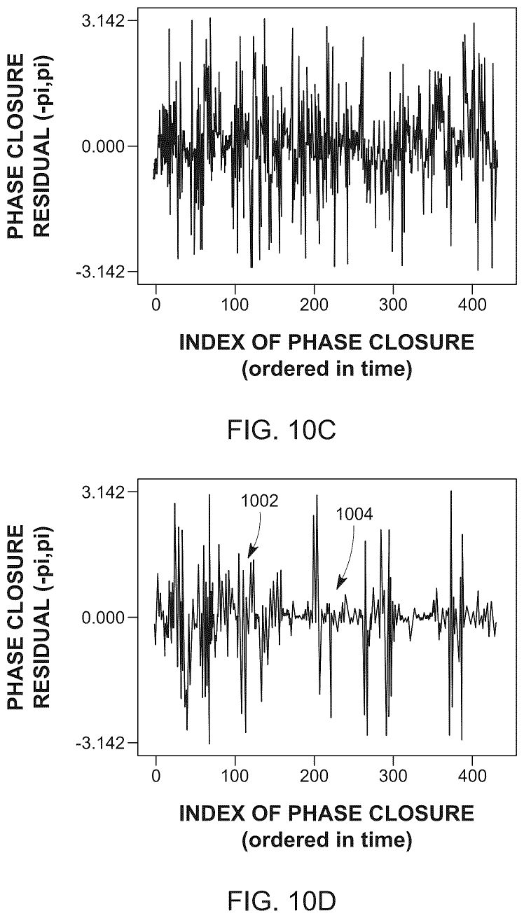

One example of this approach is illustrated in FIGS. 10A to 10D, which shows the variation of phase closure residuals on different surface objects through the time. In these figures, the x-axis is the indices of phase closures (ordered by the average date of three images in phase closures), and the y-axis is the phase closure residual (as non-absolute values, same as in FIG. 3B). FIG. 10A shows a corner reflector (CR), a manmade structure which provides very high quality InSAR measurements, and the almost zero residuals indicate no changes through the time. FIG. 10B shows a pixel on a railway track, not as perfect as the CR but still pretty stable most of the time, and some abnormal high residuals suggesting that temporal changes occurred during the observation period. On the other hand, when a surface changes rapidly, like the water case shown in FIG. 10C, then the phase closure residuals are very noisy and randomly distributed. An interesting example is the crop shown on FIG. 10D, where most of the time the phase closure residuals are noisy 1002, as for the water example, but with occasional periods 1004 showing consistently low closure residuals. This may reflect the different stages of plant life cycle, for example, high levels of change during plant growth stage but less during the seed stage or after harvest, causing phase closure residuals to fluctuate accordingly. Overall, by analysing the residuals variation through time, and combining with other sources of data (e.g., optical images), information on physical property changes of the ground surface can be obtained.

This information on surface change may be used to trigger alerts that a change has occurred, or enhance understanding of processes causing the surface change. Furthermore, it can indicate periods of surface change which temporarily impact the quality of displacement measurements from InSAR. This information can be used to optimize later stages of the InSAR processing, in particular adjusting weights and cost functions used during interferogram unwrapping, and during inversion for time series and velocity measurements.

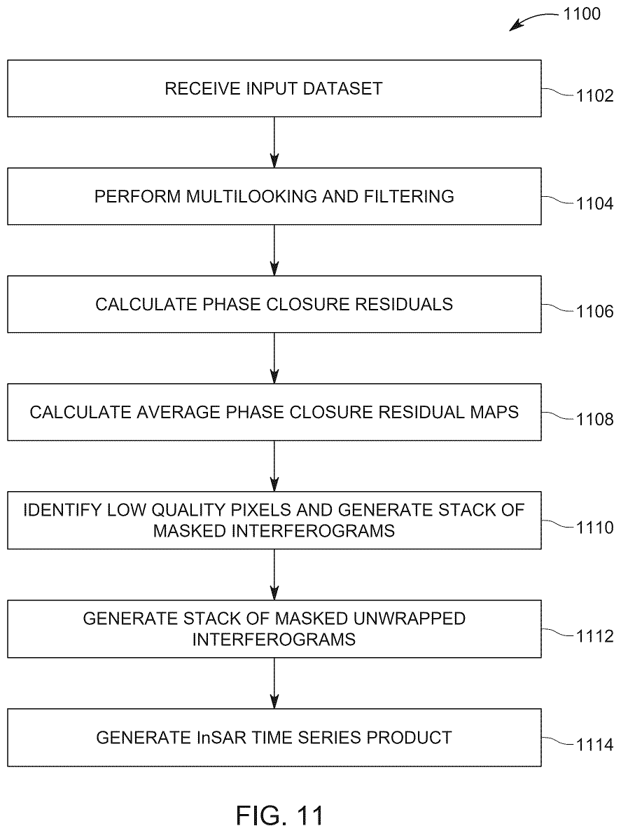

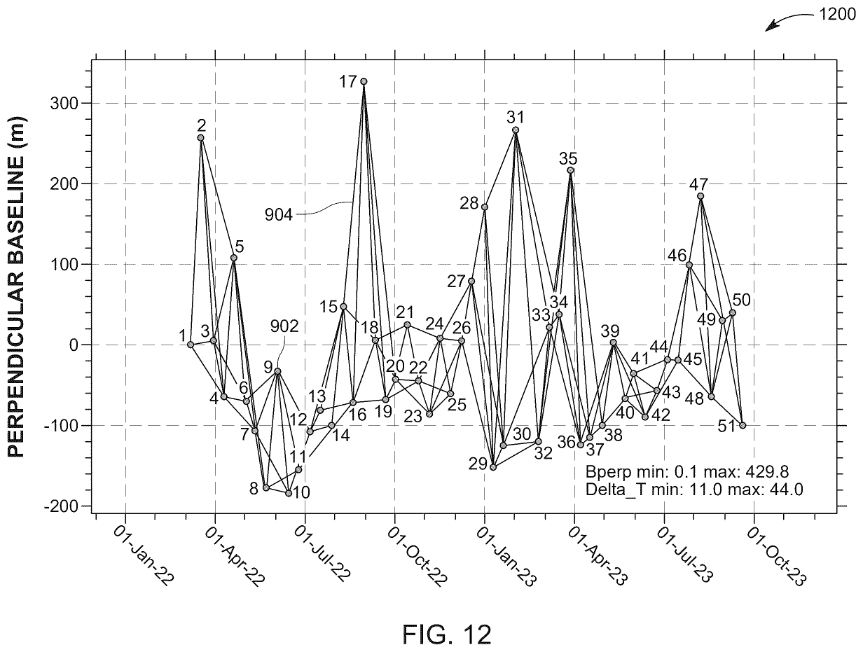

Based on the various methods disclosed above with regard to FIGS. 1A to 1D, one skilled in the art would be able to pick and choose one or more steps of these methods and create a new method. One such method 1100 is now discussed with regard to FIG. 11. However, this is not the only method that may be envisioned based on the embodiments discussed above. The method 1100 determines a structure displacement based on an input dataset that includes SAR images. The structure may be a natural object or surface (e.g., a hill), or a man-made structure (e.g., a dam). The method 1100 includes a step 1102 of receiving the input dataset, which may include a corresponding network file. The input dataset includes a stack of wrapped interferograms 103 corresponding to at least three SAR images of the structure to be investigated, taken at different times. The network file includes an interferogram network, which is a list or graph which defines how multiple SAR images are paired to form the stack of interferograms 103. FIG. 12 shows an example of the interferogram network 1200 that contains multiple phase closures. The dots 1202 and numbers represent SAR images and their indices, respectively, and the lines 1204 between them are the generated interferograms. The x and y axes are the date of the SAR images and the perpendicular baselines between them, respectively. The interferogram network is used for selecting triplets of SAR images for calculating phase closure of a loop of three SAR images.

Next, the method performs multilooking and filtering 1104 on the stack of wrapped interferograms 103 to generate multilooking interferograms 900. Multilooking may be performed using all pixels in a spatial window, or by using a subset of pixels selected by any method, for example closure-guided multilooking as discussed above with regard to FIG. 9.

As discussed above with regard to method 100A, this step breaks the phase closure consistency and causes non-zero phase closure residuals. The phase closure involves a set of three SAR images taken at different times. These three images can be paired to create three separate interferograms. Each of these interferograms will have a phase difference representing displacements in the surface between the respective pairs of images. The phase closure condition is based on summing the phase differences from these three interferograms. Ideally, if the phase measurements are consistent and free from errors, the sum of the phase differences should be exactly zero (or a multiple of 2π, which corresponds to a full wave cycle). This is known as the phase closure condition. However, in the real world the phase closure condition is not met due to various error sources, the sum deviates significantly from zero or a multiple of 2π. This deviation (the non-zero part) is known as a phase closure residual and mathematically this is the result of step 804.

In step 1106, the method calculates phase closure residual maps 107 (explained in FIGS. 1A and 1B with regard to steps 106 and 108A), based on the input dataset (or the multilooked interferograms 900). This step is based on the interferogram network 1200 received in step 1102. In step 1108, the method calculates average phase closure residual maps 109 (see discussion about step 108A and the average phase closure residual maps 109) based on the average phase closure residuals calculated in step 1106. Then, in step 1110, the method masks the pixels that are noisy, in the multilooking interferograms 900, based on the average phase closure residual maps 109 and/or coherence discussed in the method 100C illustrated in FIG. 1C (see also discussed with regard to FIG. 9). The result of this step is a stack of masked, wrapped interferograms (element 111 in the figures). In step 1112, the method unwraps the masked, wrapped interferograms 111 (see discussion above of step 110 of FIG. 1A), thus generating unwrapped, masked interferograms 115. The method then applies an InSAR time series analysis in step 1114, to the unwrapped, masked interferograms 115, to generate a InSAR time series product 117 (see discussion with regard to the method 100A in FIG. 1A). The InSAR time series product 117 may include a velocity map and/or a time series for each pixel on the map. The InSAR time series product obtained in step 1114 illustrates the displacement of the structure/object (e.g., dam) and may be used in a further step to address the displacement of the object, e.g., perform maintenance on the object, or to assess a risk associated with the displacement of the object and send an alarm to the owner of the object (e.g., the power utility running the dam). For example, such an alarm may indicate that the displacement of the dam increases the risk of imminent failure of the dam. Thus, the method 1100 is implemented for monitoring a specific structure/object and for generating warning when the structure/object is experiencing displacements beyond an expected range.

The step 1104 of performing multilooking and filtering on the stack of wrapped interferograms for reducing noise, which may break a phase closure consistency and generate non-zero phase closure residuals, may be performed using all the pixels in a spatial window (as discussed with regard to FIG. 2), or by using a subset of pixels selected by any method, for example, closure-guided multilooking (as discussed with regard to FIG. 9).

In one embodiment, the unwrapped masked interferograms 115 are directly converted into short-term Earth surface deformation maps over a given period of time. The step of performing multilooking may include performing a phase closure guided multilooking. The phase closure guided multilooking step filters out pixels from an interferogram, based on a phase closure residual of the pixels. In one application, the closure guided multilooking step filters out pixels from an interferogram, based on (1) a phase closure residual of the pixels and (2) a coherence of the pixels.

In this or another embodiment, the method may further include a step of performing a change detection of the surface based on phase closure residuals associated with the phase closure residual maps. A temporal evolution of the phase closure residuals is associated with different surface types. The method may further include determining a type of surface and an occurrence of an abnormal behavior of the surface.

In this or another embodiment, the step of calculating the average phase closure residual maps to suppress the random factors on individual maps, to obtain better noise level evaluation at pixel resolution in space. The step of masking pixels in the multilooked interferograms may further include calculating a residual pixel by pixel while a coherence measure uses a window that includes plural pixels for evaluating a noise level.

In this or another embodiment, the step of unwrapping includes using the phase closure residual maps to reflect the noise level of pixels and as an input weight function during unwrapping. The step of unwrapping may also include checking phase closure residuals, which are associated with the phase closure residual maps, of the masked unwrapped interferograms to correct the unwrapping errors. The step of generating the InSAR time series product may include performing an inversion on the unwrapped, masked interferograms, to calculate (1) a displacement of the structure for a time epoch spanned by the SAR images and (2) an associated mean velocity map.

In this or another embodiment, the step of inversion includes using the phase closure residual maps as an input weight function during the inversion, which reflect a noise level of pixels and interferograms, to suppress an impact of outliers. All the above discussed steps may be implemented in the device 1300.

The methods discussed herein may be applied, in addition to ground displacement monitoring for structures such as dams as illustrated here, to urban areas, infrastructure, and geohazards like earthquakes, volcanoes, and landslides etc. The method may also be applied to the field of subsurface exploration and production, for example hydrocarbons, geothermal, carbon capture and sequestration, and other natural resources. The method may also be employed for topographic mapping and monitoring for crop and wetland, and climate change research including ice sheets and glaciers.

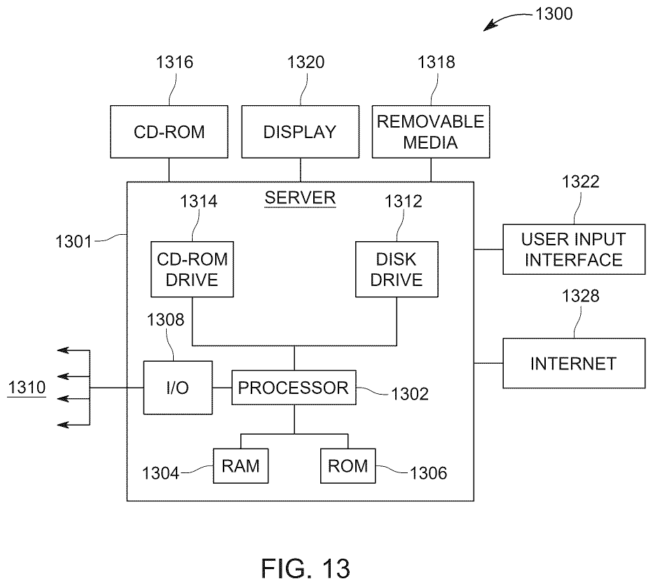

The above-discussed procedures and methods may be implemented in a computing device as illustrated in FIG. 13. Hardware, firmware, software or a combination thereof may be used to perform the various steps and operations described herein. The computing device 1300 is suitable for performing the activities described in the above embodiments and may include a server 1301. Such a server 1301 may include a central processor (CPU) 1302 coupled to a random access memory (RAM) 1304 and to a read-only memory (ROM) 1306. ROM 1306 may also be other types of storage media to store programs, such as programmable ROM (PROM), erasable PROM (EPROM), etc. Processor 1302 may communicate with other internal and external components through input/output (I/O) circuitry 1308 and bussing 1310 to provide control signals and the like. Processor 1302 carries out a variety of functions as are known in the art, as dictated by software and/or firmware instructions.

Server 1301 may also include one or more data storage devices, including hard drives 1312, CD-ROM drives 1314 and other hardware capable of reading and/or storing information, such as DVD, etc. In one embodiment, software for carrying out the above-discussed steps may be stored and distributed on a CD-ROM or DVD 1316, a USB storage device 1318 or other form of media capable of portably storing information. These storage media may be inserted into, and read by, devices such as CD-ROM drive 1314, disk drive 1312, etc. Server 1301 may be coupled to a display 1320, which may be any type of known display or presentation screen, such as LCD, plasma display, cathode ray tube (CRT), etc. A user input interface 1322 is provided, including one or more user interface mechanisms such as a mouse, keyboard, microphone, touchpad, touch screen, voice-recognition system, etc.

Server 1301 may be coupled to other devices, e.g., other data imaging systems. The server may be part of a larger network configuration as in a global area network (GAN) such as the Internet 1328, which allows ultimate connection to various landline and/or mobile computing devices.

As described above, the apparatus 1300 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 1302 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 1302 may be configured to execute instructions stored in the memory device 1304 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The term “about” is used in this application to mean a variation of up to 20% of the parameter characterized by this term.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a method for determining surface displacement in an object by masking pixels based on phase closure for enhancing the accuracy of the measurements. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for determining surface displacement in a structure based on interferometric synthetic aperture radar (InSAR), the method comprising:
receiving a stack of wrapped interferograms;
performing multilooking on the stack of wrapped interferograms to generate multilooked interferograms;
calculating phase closure residual maps based on the multilooked interferograms;
calculating average phase closure residual maps based on the phase closure residuals;
masking pixels in the multilooked interferograms, based on the average phase closure residual maps, to obtain masked interferograms;
unwrapping the masked interferograms to obtain unwrapped, masked interferograms; and
generating an InSAR time series product based on the unwrapped, masked interferograms.

2. The method of claim 1, wherein the unwrapped masked interferograms are directly converted into short-term Earth surface deformation maps over a given period of time.

3. The method of claim 1, wherein the step of performing multilooking comprises:
performing a phase closure guided multilooking.

4. The method of claim 3, wherein the phase closure guided multilooking step filters out pixels from an interferogram, based on a phase closure residual of the pixels.

5. The method of claim 3, wherein the closure guided multilooking step filters out pixels from an interferogram, based on (1) a phase closure residual of the pixels and (2) a coherence of the pixels.

6. The method of claim 1, further comprising:
performing a change detection of the surface based on phase closure residuals associated with the phase closure residual maps.

7. The method of claim 6, wherein a temporal evolution of the phase closure residuals is associated with different surface types various, the method further comprising:
determining a type of surface and an occurrence of an abnormal behavior of the surface.

8. The method of claim 1, wherein the step of calculating the average phase closure residual maps to suppress the random factors on individual maps, to obtain better noise level evaluation at pixel resolution in space.

9. The method of claim 1, wherein the step of masking pixels in the multilooked interferograms further comprises:
calculating a residual pixel by pixel while a coherence measure uses a window that includes plural pixels for evaluating a noise level.

10. The method of claim 1, wherein the step of unwrapping comprises:
using the phase closure residual maps to reflect the noise level of pixels and as an input weight function during unwrapping.

11. The method of claim 1, wherein the step of unwrapping comprises:
checking phase closure residuals, which are associated with the phase closure residual maps, of the masked unwrapped interferograms to correct the unwrapping errors.

12. The method of claim 1, wherein the step of generating the InSAR time series product comprises:
performing an inversion on the unwrapped, masked interferograms, to calculate (1) a displacement of the structure for a time epoch spanned by the SAR images and (2) an associated mean velocity map.

13. The method of claim 12, wherein the step of inversion comprises:
using the phase closure residual maps as an input weight function during the inversion, which reflect a noise level of pixels and interferograms, to suppress an impact of outliers.

14. A computing system for determining displacement in a structure based on interferometric synthetic aperture radar (InSAR), the computing system comprising:
an interface configured to receive a stack of wrapped interferograms; and
a processor connected to the interface and configured to:
perform multilooking on the stack of wrapped interferograms to generate multilooked interferograms;
calculate phase closure residual maps based on the multilooked interferograms;
calculate average phase closure residual maps based on the phase closure residuals;
mask pixels in the multilooked interferograms, based on the average phase closure residual maps, to obtain masked interferograms;
unwrap the masked interferograms to obtain unwrapped, masked interferograms; and
generate an InSAR time series product based on the unwrapped, masked interferograms.

15. The system of claim 14, wherein the unwrapped masked interferograms are directly converted into short-term Earth surface deformation maps over a given period of time.

16. The system of claim 14, wherein the processor is further configured to:
perform a phase closure guided multilooking.

17. The system of claim 16, wherein the phase closure guided multilooking step filters out pixels from an interferogram, based on:
a phase closure residual of the pixels, or
(1) a phase closure residual of the pixels and (2) a coherence of the pixels.

18. The system of claim 14, wherein the processor is further configured to:
perform a change detection of the surface based on phase closure residuals associated with the phase closure residual maps.

19. The system of claim 18, wherein a temporal evolution of the phase closure residuals is associated with different surface types various, the processor being further configured to:
determine a type of surface and an occurrence of an abnormal behavior of the surface.

20. The system of claim 14, wherein the processor is further configured to:
suppress the random factors on individual maps, to obtain better noise level evaluation at pixel resolution in space; and
calculate a residual pixel by pixel while a coherence measure uses a window that includes plural pixels for evaluating a noise level.
